(19) United States
(12) Patent Application Publication
(10) Pub. No.: US 2021/0305827 A1
(43) Pub. Date: Sep. 30, 2021

(54) CHARGER

(71) Applicant: Guangdong Mcdodo Industrial Company Limited, Guangzhou (CN)

(72) Inventor: Yuxin Guo, Guangzhou (CN)

(73) Assignee: Guangdong Mcdodo Industrial Company Limited

(21) Appl. No.: 17/343,751

(22) Filed: Jun. 10, 2021

(30) Foreign Application Priority Data
Apr. 27, 2021 (CN) 202120893953.0

(51) Int. Cl. H02J 7/00; H01R 31/06; H01R 13/506

(52) U.S. Cl. CPC H02J 7/0047; H01R 13/506; H01R 31/06

(57) ABSTRACT

The invention relates to the technical field of chargers, in particular to a charger comprising a plug and a base which are detachably connected. The plug is provided with sliding slots and a clamping piece. The base is provided with sliding rails corresponding to the sliding slots and a clamping plate corresponding to the clamping piece. When the plug is connected to the base, the sliding slots slide in along the sliding rails, and the clamping piece clamps the clamping plate.

### BACKGROUND OF THE INVENTION

### 1. Technical Field

The invention, relates to the technical field of chargers, in particular to a charger.

### 2. Description of Related Art

Different countries set different standards of plugs for electrical devices. Plugs commonly used in China are Chinese-standard plugs, and there are also American-standard plugs, British-standard plugs, European-standard plugs and South Africa-Standard plugs in other countries. Plugs of different standards cannot be used universally. With the popularization of electronic products and the acceleration of internationalization such non-universal standards cause great inconvenience, to people in life. In view of this, chargers adaptable to different plugs have come into being on the market. However, existing chargers adaptable to different plugs cannot guarantee the connection stability and may lead to unstable electrical connection, so the user experience is poor.

### BRIEF SUMMARY OF THE INVENTION

The technical issue to be settled by the invention is to solve the problem of unstable connection of existing chargers adaptable to different plugs by providing a charger.

The solution adopted by the invention to settle the above-mentioned technical issue is to provide a charger, which comprises a plug and a base which are detachably connected, wherein the plug is provided with sliding rails and a clamping piece, and the base is provided with sliding rails corresponding to the sliding slots and a clamping plate corresponding to the clamping piece; and when the plug is connected to the base, the sliding slots slide in along the sliding rails, and the clamping piece clamps the clamping plate.

Preferably, the charger further comprises a push module, wherein the push module comprises a push seat and a push plate which are slidably connected, the push seat is located on the base, a push block is disposed on a side, close to the base, of the push plate, and when the push plate slides towards the plug and pushes the plug, the push block presses against the clamping piece to enable the clamping piece to be separated from the clamping plate.

Preferably, electrode elastic pieces stretch out of the base, electrical connection slots are formed in the plug, channels are formed in ends, close to the push seat, of the electrical connection slots, and when the sliding slots slide in along the sliding rails, the electrode elastic pieces enter the electrical connection slots along the channels; and the height of the channels is smaller than the height of the electrode elastic pieces stretching out of the base.

Preferably, limit slots are formed in side walls of the sliding rails, limit blocks corresponding, to the limit slots are disposed on inner walls of the sliding slots, and when the sliding slots slide in along the sliding rails, the limit blocks enter the limit slots.

Preferably, the clamping piece comprises two hooks that are arranged oppositely, a trapezoidal portion is disposed at an end, close to the clamping piece, of the push block, and when the push plate slides towards the plug, the trapezoidal, portion enters a gap between the two hooks and pushes the two hooks away from each other.

Preferably, the push block is formed with a cavity, and a stop corresponding to the cavity is disposed on the base and stretches into the cavity; the push module further comprises an elastic element having an end abutting against the stop and an end abutting against an inner wall of the cavity.

Preferably, a first concave surface is disposed on a side, away from the base, of the push seat, a second concave surface is disposed on the plug, and when the plug is connected to the base, the first concave surface and the second concave surface define a sliding space; and the push plate is disposed on the first concave surface and at least partially stretches onto the second concave surface.

Preferably, the first concave surface is provided with a notch corresponding to the push block and convex ribs disposed on two sides of the notch, and the convex ribs are parallel to a sliding direction of the push plate.

Preferably, the base is further provided with guide blocks disposed on sides, away from the clamping plate, of the electrode elastic pieces; and when the sliding slots slide in along the sliding rails, the channels sequentially slide through the guide blocks and the electrode elastic pieces.

Preferably, the plug is any one selected from a Chinese-standard plug, an American-standard plug, a European-standard plug, British-standard plug, a South Africa-standard plug, and plugs up to standards in other countries.

Compared with the prior art, the charger of the invention has the following advantages:

1. According to the charger of the invention, by means of the sliding slots and the sliding rails corresponding to the sliding slots, the plug can be easily and accurately pushed to an installation site and can be restrained from shaking laterally; by means of the clamping piece and the clamping plate corresponding to the clamping piece, the plug can be firmly fixed to be restrained from shaking forwards or backwards; after being installed in place, the plug is firmly fixed to the installation site, so that stable electrical connection is guaranteed, the problem of unstable connection of existing chargers adaptable to different plugs is solved, and the user experience is greatly improved.

2. According to the charger of the invention, the push plate provided with the push block is configured, and the push block can press against the clamping piece to enable the clamping piece to be separated from the clamping plate; when the push plate pushes the plug forwards, the clamping piece and the clamping plate are unhooked and disconnected to release the plug, and then the push plate can easily separate the plug from the base, so that the plug can be easily disassembled, and the user experience is further improved.

3. According to the charger of the invention, the channels are formed in the ends, close to the push seat, of the electrical connection slots; when the plug is pushed out, the electrode elastic pieces slide out of the channels; the height, of the channels is, set to be smaller than the height of the electrode elastic pieces stretching out of the base, so that when the plug slides outwards, the electrode elastic pieces block the channels from the front at first, so the plug will not pop out suddenly and will stay on the sliding rails after being separated from the clamping plate; then users pull the plug out from the sliding rails, and at this moment, the electrode elastic pieces deform elastically and pass through the channels; and finally, the plug is disassembled. In this way, the plug will not pop out, fall or get lost when disassembled, the safety in the replacement process is guaranteed, and the user experience is improved.

4. According to the invention, the limit slots are formed in the inner walls of the sliding rails and the limit blocks are disposed on the inner wall of the sliding slots correspondingly, so that the sliding slots can be prevented from disengaging from the upper edges of the sliding rails, the plug can be guided more steadily when assembled and disassembled, and the user experience is further improved.

5. The push module of the invention comprises the elastic element which enables the push plate to restore automatically and restrains the push plate from shaking forwards or backwards, so that the integrity of the push module is better; and after restoring automatically, the push plate will not exert an influence on the plug when the plug slides in, so that installation is smoother.

6. According to the invention, the first concave surface is disposed on the push seat and the second concave surface is correspondingly disposed on the plug, and the push plate can sink into the two concave surfaces to make the surface integrity of the charger better and will not protrude out, so that the customer experience is better. In addition, at least one part of the push plate stretches onto the second concave surface, so that the push plate can shield a joint between the plug and the base, which makes the overall appearance of the charger more attractive, and the integrity and the user experience are further improved.

7. According to the invention, the convex ribs are disposed on the first concave surface, and the push plate only contacts with the convex ribs on the first concave surface, so that the bottom surface of the push plate is changed to surface-line contact, which avoids the influence of unevenness caused by surface-surface contact and allows the push plate to be pushed more smoothly, and the user experience is further improved.

8. According to the invention, the base is further provided with the guide blocks disposed on the sides, away from the clamping plate, of the electrode elastic pieces, and when the sliding slots slide in along the sliding rails, the channels sequentially slide through the guide blocks and the electrode elastic pieces. By means of the guide blocks, the electrode elastic pieces can be aligned to the channels in advance and then be guided to enter the channels, so that the channels generate less abrasion on the electrode elastic pieces, the service life is prolonged, and the practicability is improved.

### BRIEF DESCRIPTION OF THE SEVERAL VIEWS OF THE DRAWINGS

To more clearly explain the technical solutions of the embodiments of the invention, drawings used for describing the embodiments of the invention or the prior art will be briefly introduced below. Obviously, the drawings in the following description merely illustrate some embodiments of the invention, and those ordinarily skilled in the art can obtain other drawings according to the following ones without creative labor.

FIG. 1 is a first perspective structural view of a charger according to Embodiment 1 of the invention.

FIG. 2 is a second perspective view of the charger according to Embodiment 1 of the invention.

FIG. 3 is a schematic diagram of a charger provided with a European-standard plug according to Embodiment 1 of the invention.

FIG. 4 is a schematic diagram of a charger provided with a British-standard plug according to Embodiment 1 of the invention.

FIG. 5 is a first exploded view of the charger according to Embodiment 1 of the invention.

FIG. 6 is a second exploded view of the charger according to Embodiment 1 of the invention.

FIG. 7 is a third exploded view of the charger according to Embodiment 1 of the invention.

FIG. 8 is a partial sectional view of the charger according to Embodiment 1 of the invention.

### REFERENCE SIGNS

1, charger;
10, plug; 10-1, European-standard plug; 10-2, British-standard plug; 20, base; 30, push module;
101, conducting pillar; 102, sliding slot; 103, clamping piece; 104, second concave surface; 105, electrical connection slot; 201, output interface; 202, sliding rail; 203, clamping plate; 204, stop; 205, U-shaped limit seat; 206, electrode elastic piece; 207, guide block; 301, push seat; 302, push plate; 303, elastic element;
1021, limit block; 1031, hook; 1032, claw portion; 1033, claw-free portion; 1051, channel; 2021, limit slot; 2041, protruding pillar; 3011, first concave surface; 3012, notch; 3013, convex rib; 3014, flange; 3021, push block; 3022, trapezoidal portion; 3023, cavity; 3024, edge slot.

### DETAILED DESCRIPTION OF THE INVENTION

To make the purposes, technical solutions, and advantages of the invention clearer, the invention will be described in further detail below in conjunction with the accompanying drawings and embodiments. It should be understood that the specific embodiments in the following description are merely used to explain the invention, and are not intended to limit the invention.

It should be noted that when one element is regarded as being “fixed to” the other element, it may be directly disposed on the other element, or there may exist an intermediate element between the two elements. When one element is regarded as being “connected to” the other element, it may be directly connected to the other element, or there may exist an intermediate element between the two elements. The terms such as “vertical”, “horizontal”, “left” and “right”, and similar expressions in this specification are merely for the purpose of description.

The terms such as “upper”, “lower”, “left”, “right”, “front”, “back”, “top”, “bottom”, “inner”, “outer”, “central”, “vertical”, “horizontal”, “crosswise” and “lengthwise” in the invention are used to indicate directional or positional relations based on the accompanying drawings. These terms are mainly used for better describing the invention and the embodiments of the invention, and do not indicate that devices, elements, or constituent parts referred to must have a specific direction or be configured and operated in a specific direction.

In addition, part of these terms are not only used to express directional or positional relations, they may also have other meanings. For example, the term “upper” may express a certain attachment relation or connection relation in some cases. Those ordinarily skilled in the art can appreciate the specific meanings of these terms in the invention as the case may be.

Moreover, the terms “install”, “dispose”, “provided with”, and “connection” and “connect” should be broadly understood. For example, “connection” may refer to fixed connection, detachable connection or integrated connection, or mechanical connection or electrical connection, or direct connection or indirect connection via an intermediate medium, or internal communication of two devices, elements, or constituent parts. Those ordinarily skilled in the art can appreciate the specific meanings of these terms in the invention as the case may be.

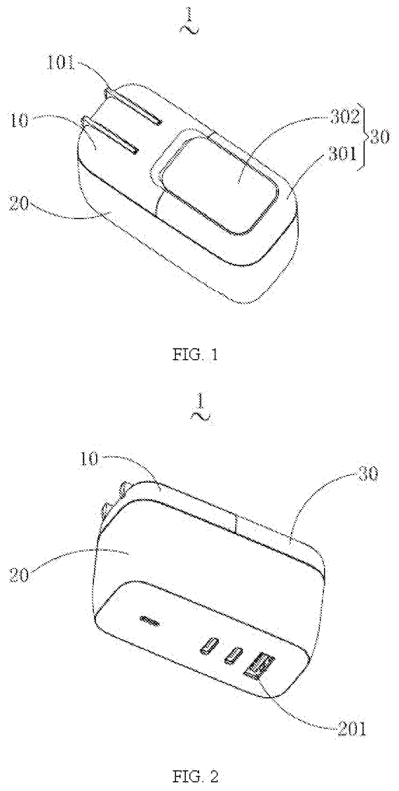

Referring to FIG. 1-FIG. 4, Embodiment 1 of the invention provides a charger 1, which comprises a plug 10 and a base 20 which are detachably connected, wherein when the plug 10 and the base 20 are connected, the interior of the plug 10 and the interior of the base 20 are electrically connected. The plug 10 can be plugged into an external power socket, and the base 20 can charge electronic devices by means of an external charging cable.

It can be understood that conducting pillars 101 are disposed on the plug 10 to be plugged into the external power socket, and that a PCBA (not shown) is disposed in the base 20 to regulate a required output voltage and a required output current.

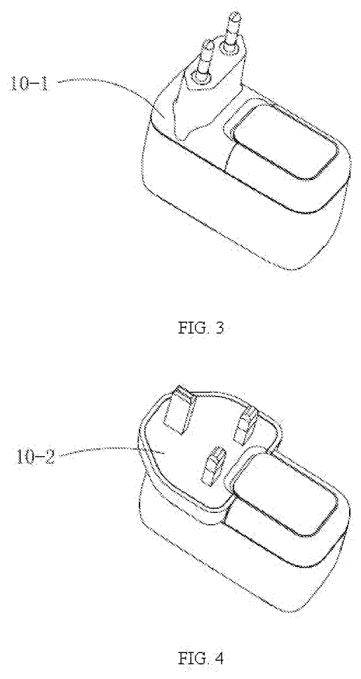

Optionally, the plug 10 may be any one selected from a Chinese-standard plug, an American-standard plug, a European-standard plug (as shown in FIG. 3), a British-standard plug (as shown in FIG. 4), a South Africa-standard plug, and plugs up to standards in other countries.

Optionally, the charging cable is fixedly or pluggably connected to the base 20. Specifically, in this embodiment of the invention, the base 20 is provided with at least one output interface 201, and the charging cable is pluggably connected to the output interface 201.

Optionally, when the base 20 is provided with one output interface 201, the output interface 201 may be any one selected from a USB interface, a MicroUSB interface, a Type-C interface, or a Linghtning interface.

Optionally, when the base 20 is provided with two or more output interfaces 201, the output interfaces may be any one selected from USB interfaces, MicroUSB interfaces, Type-C interfaces, or Linghtning interfaces, that is, the multiple output interfaces 201 are of the same type, so that multiple identical electronic devices can be charged at the same time. Or, the output interfaces 201 are more than one selected from USB interfaces, MicroUSB interfaces, Type-C interfaces, or Linghtning interfaces, that is, the multiple output interfaces 201 are of different types, so that different electronic devices can be charged at the same time.

Furthermore, referring to FIG. 1 and FIG. 5-FIG. 6, the plug 10 is provided with sliding slots 102 and a clamping piece 103, the base 20 is provided with sliding rails 202 corresponding to the sliding slots 102 and a clamping plate 203 corresponding to the clamping piece 103, and when the plug 10 is connected to the base 20, the sliding slots 102 slide in along the sliding rails 202, and the clamping piece 103 clamps the clamping plate 203. By means of the sliding slots 102 and the sliding rails 202 corresponding to the sliding slots 102, the plug 10 can be easily and accurately pushed to an installation site and can be restrained from shaking laterally; and by means of the clamping piece 103 and the clamping plate 203 corresponding to the clamping piece 103, the plug 10 can be firmly fixed to be restrained from shaking forwards or backwards. After being installed in place, the plug 10 is firmly fixed to the installation site, so that stable electrical connection is guaranteed, the problem of unstable connection of existing chargers adaptable to different plugs is solved, and the user experience is greatly improved.

Furthermore, the charger 1 further comprises a push module 30, wherein the push module 30 comprises a push seat 301 and a push plate 302 which are slidably connected, and the push seat 301 is located on the base 20. A push block 3021 is disposed on a side, close to the base 20, of the push plate 302, and when the push plate 302 slides towards the plug 10 and pushes the plug 10, the push block 3021 presses against the clamping piece 103 to enable the clamping piece 103 to be separated from the clamping plate 203. In this way, when the push plate 302 pushes the plug 10 forwards, the clamping piece 103 and the clamping plate 203 are unhooked and disconnected to release the plug 10, and then, the push plate 302 can easily separate the plug 10 from the base 20. So, the plug 10 can be easily assembled and disassembled, and the problem of inconvenient plug replacement of existing chargers is solved.

Optionally, the push seat 301 may be connected to the base 20 with bolts, buckles, or glue. Specifically, in this embodiment of the invention, the push seat 301 is connected to the base 20 with buckles.

Furthermore, limit slots 2021 are formed in side walls of the sliding rails 202, limit blocks 1021 corresponding to the limit slots 2021 are disposed on inner walls of the sliding slots 102, and when the sliding slots 102 slide in along the sliding rails 202, the limit blocks 1021 enter the limit slots 2021. In this way, the sliding slots 102 can be prevented from disengaging from upper edges of the sliding rails 202, that is, the sliding slots 102 are prevented from derailing, so that the plug 10 is guided more steadily when assembled and disassembled, and the user experience, is further improved.

Optionally, the limit slots 2021 may be formed in one side wall of each sliding rail 202 or be formed in two side walls of each sliding rail 202, and the limit blocks 1021 in the sliding slots 102 correspond to the limit slots 2021. Specifically, in this embodiment of the invention, the limit slots 2021 are formed in one side wall of each sliding rail 202 and are formed in opposite side walls of the two sliding rails.

Optionally, one or more limit blocks 1021 may be configured and may be square or sectorial as long as the limit blocks can, smoothly enter the limit slots 2021.

Furthermore, the clamping piece 103 comprises two hooks 1031 that are arranged oppositely, a trapezoidal portion 3022 is disposed at an end, close to the clamping piece 103, of the push block 3021, and when the push plate 302 slides towards the plug 10, the trapezoidal portion 3022 enters a gap between the two hooks 1031 and pushes the two hooks 1031 away from each other.

It can be understood that the trapezoidal portion 3022 has a narrow end and a wide end and the distance between the two hooks 1031 is greater than the width of the narrow end and smaller than the width of the wide end. The narrow end enters the gap between the two hooks 1031 at first and then gradually extends to the wide end to push the two hooks 1031 away from each other.

Furthermore, each hook 1031 comprises a claw portion 1032 and a claw-free portion 1033, the claw portions 1032 are used to clamp the clamping plate 203, and the trapezoidal portion 3022 is moved and inserted between the claw-free portions 1033. In this way, the influence of the clamping plate 203 can be avoided, and the trapezoidal portion 3022 can push the two hooks 1031 away from each other more smoothly.

Furthermore, the push block 3021 is formed with a cavity 3023, the base 20 is provided with a stop 204 corresponding to the cavity 3023, and when the push module 30 is connected to the base 20, the stop 204 stretches into the cavity 3023. The push block 30 further comprises an elastic element 303 having one end abutting against the stop 204 and the other end abutting against an inner wall of the cavity 3023. The elastic element enables the push plate to restore automatically and can restrain the push plate from shaking forwards or backwards, so that the integrity of the push module is better; and after restoring automatically, the push plate will not exert an influence on the plug when the plug slides in, which makes installation smoother.

It can be understood that when the push plate 302 is pushed forwards, the inner wall, of the cavity 3023 presses against one end of the elastic element 303 so that the end, towards the stop 204, of the elastic element 303 contracts and deforms to generate a deformative elastic force; and when the push plate 302 is released, the deformative elastic force acts on the inner wall of the cavity 3023 to enable the push plate 302 to restore. In addition, the elastic element 303 can restrain the push plate 302 from shaking forwards or backwards, which makes the integrity of the push module 30 better; and after restoring automatically, the push plate 302 will not exert an influence on the plug 10 when the plug 10 slides in, so that installation is smoother.

Optionally, the elastic element 303 may be a spring, an elastic piece, or other elastic materials. Specifically, in this embodiment of the invention, the elastic element 303 is a spring.

Furthermore, a protruding pillar 2041 is disposed on a side, in contact with the elastic element 303, of the stop 204, and the elastic element 303 may be disposed around the protruding pillar 2041 to be limited and prevented from being deflected, which may otherwise affect the restoration effect. Furthermore, a U-shaped limit seat 205 corresponding to the elastic element 303 may be disposed on the base 20 to further limit the elastic element 303.

Furthermore, referring to FIG. 1 and FIG. 7, a first concave surface 3011 is disposed on a side, away from the base 20, of the push seat 301, and a second concave surface 104 is disposed on the plug 10; and when the plug 10 is connected to the base 20, the first concave surface 3011 and the second concave surface 104 define a first sliding space, and the push plate 302 is disposed on the first concave surface 3011 and at least partially stretches onto the second concave surface 104. In this way, the push plate 302 can shield a joint of the plug 10 and the base 20 to make the overall appearance of the charger 1 more attractive, and the integrity and the user experience are further improved.

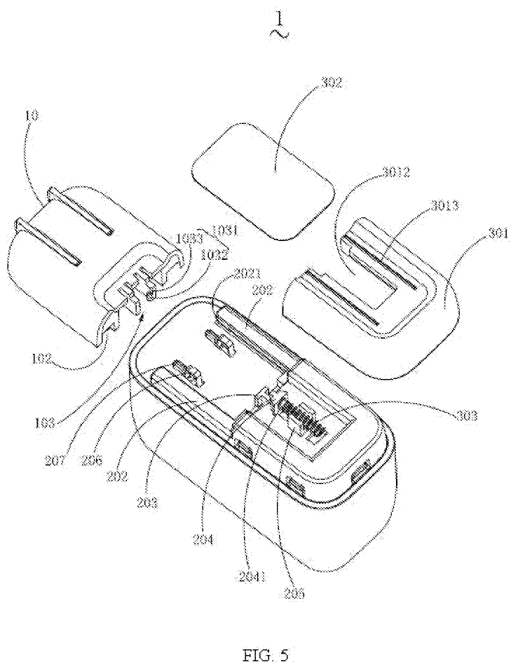

Furthermore, referring to FIG. 5-FIG. 7, the first concave surface 3011 is provided with a notch 3012 corresponding to the push block 3021 and convex ribs 3013 disposed on two sides of the notch 3012, and the convex ribs 3013 are parallel to the sliding direction of the push plate 302. In this way, the bottom surface of the push plate 302 is changed to surface-line contact, which avoids the influence of unevenness caused by surface-surface contact and allows the push plate 302 to be pushed more smoothly, and the user experience is further improved.

Furthermore, flanges 3014 oppositely extend out from the notch 3012, edge slots 3024 corresponding to the flanges 3014 are disposed on two sides of the push block 3021, and the flanges 3014 slide in the corresponding edge slots 3024 to push the push plate 302 forwards or backwards.

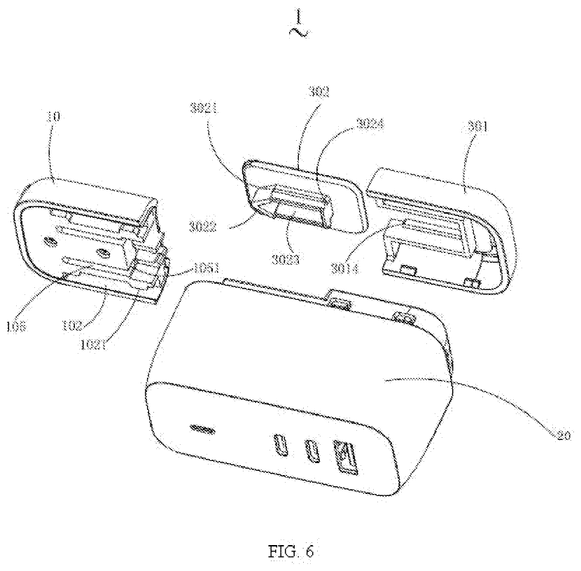

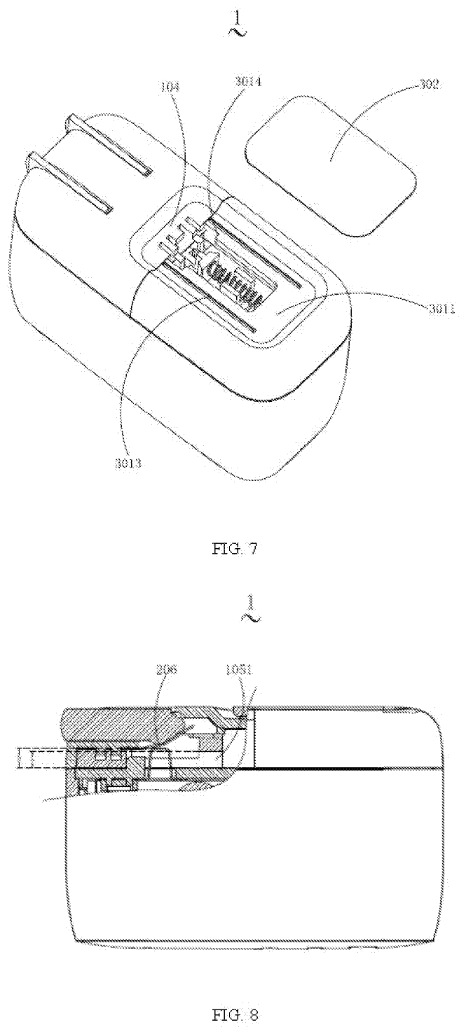

Furthermore, referring to FIG. 5, FIG. 6, and FIG. 8, electrode elastic pieces 206 stretch out of the base 20, electrical connection slots 105 corresponding to the electrode elastic pieces 206 are formed in the base 10, and channels 1051 are formed in ends, close to the push seat 301, of the electrical connection slots 105; when the sliding slots 102 slide in along the sliding rail 202, the electrode elastic pieces 206 slide through the channels 1051 to enter the electrical connection slots 105; and the height h (shown in FIG. 6) of the channels 1051 is smaller than the height. H (shown in FIG. 6) of the electrode elastic pieces 206 stretching out of the base. It can be understood that when the plug 10 slides outwards, the electrode elastic pieces 206 block the channels 1051 from the front, so that the plug 10 will not pop out suddenly and will stay on the sliding rails 202 after being separated from the clamping plate 203, then users pull the plug 10 out from the sliding rails 202, at this moment, the electrode elastic pieces 206 deform elastically and pass through the channels 1051, and finally, the plug 10 is disassembled. In this way, the plug will not pop out, fall, or get lost when disassembled, the safety in the replacement process is guaranteed, and the user experience is improved.

Furthermore, the base 20 is further provided with guide blocks 207 disposed on sides, away from the clamping plate 203, of the electrode elastic pieces 206, and when the sliding slots 102 slide in along the sliding rails 202, the channels 1051 sequentially slide through the guide blocks 207 and the electrode elastic pieces 206. By means of the guide blocks 207, the electrode elastic pieces 206 can be aligned to the channels 1051 in advance and can be guided to enter the channels 1051, so that the channels 1051 generate less abrasion on the electrode elastic pieces 206, the service life is prolonged, and the practicability is improved.

Compared with the prior art, the charger of the invention has the following advantages:

1. According to the charger of the invention, by means of the sliding slots and the sliding rails corresponding to the sliding slots the plug can be easily and accurately pushed to an installation site and can be restrained from shaking laterally; by means of the clamping piece and the clamping plate corresponding to the clamping piece, the plug can be firmly fixed to be restrained from shaking forwards or backwards; after being installed in place, the plug is firmly fixed to the installation site, so that stable electrical connection is guaranteed, the problem of unstable connection of existing chargers adaptable to different plugs is solved, and the user experience is greatly improved.

2. According to the charger of the invention, the push plate provided with the push block is configured, and the push block can press against the clamping piece to enable the clamping piece to be separated from the clamping plate; when the push plate pushes the plug forwards, the clamping piece and the clamping plate are unhooked and disconnected to release the plug, and then the push plate can easily separate the plug from the base, so that the plug can be easily disassembled, and the user experience is further improved.

3. According to the charger of the invention, the channels are formed in the ends, close to the push seat, of the electrical connection slots; when the plug is pushed out, the electrode elastic pieces slide out of the channels; the height of the channels is set to be smaller than the height of the electrode elastic pieces stretching out of the base, so that when the plug slides outwards, the electrode, elastic pieces block the channels from the front, so the plug will not pop out suddenly and will stay on the sliding rails after being separated from the clamping plate; then users pull the plug out from the sliding rails, and at this moment, the electrode elastic pieces deform elastically and pass through the channels; and finally, the plug is disassembled. In this way, the plug will not pop out, fall, or get lost when disassembled, the safety in the replacement process is guaranteed, and the user experience is improved.

4. According to the invention, the limit slots are formed in the inner walls of the sliding rails and the limit blocks are disposed on the inner wall of the sliding slots correspondingly, so that the sliding slots can be prevented from disengaging from the upper edges of the sliding rails, the plug can be guided more steadily when assembled and disassembled, and the user experience is further improved.

5. The push module of the invention comprises the elastic element which enables the push plate to restore automatically and restrains the push plate from shaking forwards or backwards, so that the integrity of the push module is better; and after restoring automatically, the push plate will not exert an influence on the plug when the plug slides in, so that installation is smoother.

6. According to the invention, the first concave surface is disposed on the push seat and the second concave surface is disposed on the plug correspondingly, and the push plate can sink into the two concave surfaces to make the surface integrity of the charger better and will not protrude out, so that the customer experience is better. In addition, at least one part of the push plate stretches onto the second concave surface, so that the push plate can shield the joint between the plug and the base, which makes the overall appearance of the charger more attractive, and the integrity and the user experience are further improved.

7. According to the invention, the convex ribs are disposed on the first concave surface, and the push plate only contacts with the convex ribs on the first concave surface, so that the bottom surface of the push plate is changed to surface-line contact, which avoids the influence of unevenness caused by surface-surface contact and allows the push plate to be pushed, more smoothly, and the user experience is further improved.

8. According to the invention, the base is further provided with the guide blocks disposed on the sides, away from the clamping plate, of the electrode elastic pieces, and when the sliding slots slide in along the sliding rails, the channels sequentially slide through the guide blocks and the electrode elastic pieces. By means of the guide blocks, the electrode elastic pieces can be aligned to the channels in advance and then be guided to enter the channels, so that the channels generate less abrasion on the electrode elastic pieces, the service life is prolonged, and the practicability is improved.

The above embodiments are merely preferred ones of the invention, and are not intended to limit the invention. Any modifications, equivalent substitutions and improvements made based on the principle of the invention should also fall within the protection scope of the invention.

What is claimed is:

1. A charger, comprising a plug and a base which are detachably connected, wherein the plug is provided with sliding rails and a clamping piece, and the base is provided with sliding rails corresponding to the sliding slots and a clamping plate corresponding to the clamping piece; and when the plug is connected to the base, the sliding slots slide in along the sliding rails, and the clamping piece clamps the clamping plate.

2. The charger according to claim 1, further comprising a push module, wherein the push module comprises a push seat and a push plate which are slidably connected, the push seat is located on the base, a push block is disposed on a side, close to the base, of the push plate, and when the push plate slides towards the plug and pushes the plug, the push block presses against the clamping piece to enable the clamping piece to be separated from the clamping plate.

3. The charger according to claim 2, wherein electrode elastic pieces stretch out of the base, electrical connection slots are formed in the plug, channels are formed in ends, close to the push seat, of the electrical connection slots, and when the sliding slots slide in along the sliding rails, the electrode elastic pieces enter the electrical connection slots along the channels; and a height of the channels is smaller than a height of the electrode elastic pieces stretching out of the base.

4. The charger according to claim 1, wherein limit slots are formed in side walls of the sliding rails, limit blocks corresponding to the limit slots are disposed on inner walls of the sliding slots, and when the sliding slots slide in along the sliding rails, the limit blocks enter the limit slots.

5. The charger according to claim 2, wherein the clamping piece comprises two hooks that are arranged oppositely, a trapezoidal portion is disposed at an end, close to the clamping piece, of the push block, and when the push plate slides towards the plug, the trapezoidal portion enters a gap between the two hooks and pushes the two hooks away from each other.

6. The charger according to claim 2, wherein the push block is formed with a cavity, and a stop corresponding to the cavity is disposed on the base and stretches into the cavity;
the push module further comprises an elastic element having an end abutting against the stop and an end abutting against an inner wall of the cavity.

7. The charger according to claim 2, wherein a first concave surface is disposed on a side, away from the base, of the push seat, a second concave surface is disposed on the plug, and when the plug is connected to the base, the first concave surface and the second concave surface define a sliding space; and the push plate is disposed on the first concave surface and at least partially stretches onto the second concave surface.

8. The charger according to claim 7, wherein the first concave surface is provided with a notch corresponding to the push block and convex ribs disposed on two sides of the notch, and the convex ribs are parallel to a sliding direction of the push plate.

9. The charger according to claim 3, wherein the base is further provided with guide blocks disposed on sides, away from the clamping plate, of the electrode elastic pieces; and when the sliding slots slide in along the sliding rails, the channels sequentially slide through the guide blocks and the electrode elastic pieces.

10. The charger according to claim 1, wherein the plug is any one selected from a Chinese-standard plug, an American-standard plug, a European-standard plug, British-standard plug, a South Africa-standard plug, and plugs up to standards in other countries.
